(19) United States
(12) Patent Application Publication
(10) Pub. No.: US 2015/0379304 A1
(43) Pub. Date: Dec. 31, 2015

(54) DETECTION METHOD

(71) Applicant: MediaTek Singapore Pte. Ltd., Singapore (SG)

(72) Inventors: Ching-Ho CHAN, Taoyuan City (TW); Dayu WANG, Binhai County (CN); Bo ZHANG, Yidu City (CN)

(21) Appl. No.: 14/754,015

(22) Filed: Jun. 29, 2015

(30) Foreign Application Priority Data
Jun. 30, 2014 (CN) 201410307111.7

(51) Int. Cl. G06F 21/64; G06F 17/30; G06F 21/62; G06F 12/14

(52) U.S. Cl. CPC G06F 21/64; G06F 12/1408; G06F 17/30091; G06F 17/30218; G06F 21/6218; G06F 2212/1052; G06F 2221/2107

(57) ABSTRACT

A detection method, used in a mobile terminal, includes at least the following steps: receiving a test instruction; obtaining current storage integrity information of the mobile terminal according to the test instruction; matching the current storage integrity information and original storage integrity information, and outputting information indicating that the current system of the mobile terminal is an incomplete system when the matching fails.

### CROSS REFERENCE TO RELATED APPLICATIONS

This Application claims priority of China Patent Application No. 201410307111.7, filed on Jun. 30, 2014, the entirety of which is incorporated by reference herein.

### BACKGROUND OF THE INVENTION

1. Field of the Invention

The present invention relates to telecommunication and in particular to a detection method and a mobile terminal utilizing the same.

2. Description of the Related Art

For a portable electronic device, such as a mobile terminal including a handset, when the mobile terminal malfunctions and requires maintenance, the manufacturer often cannot identify the problem comes from the quality of the mobile terminal or is due to modifications of the original system of the mobile terminal, consequently, it is difficult to repair the mobile terminal in a fast and efficient manner.

When being produced from a factory, a mobile terminal carries an original system or an officially released system, which is not allowed to be modified after leaving the factory, thereby providing system stability in operation. Nevertheless, many mobile terminals nowadays such as smart phones or tablets adopt an open system such as an Android system. In the open system, a user may make modifications to the original system or officially released system by way of rooting to provide a personalized operating system. For example, desktop icons may be re-arranged by modifying the original system to personalize the system interface. The modified system is no longer the officially released system, but a personalized system.

However, the original system belongs to the officially released system provided by the manufacturer of the mobile terminals, and any modification may pose certain risks to the officially released system. The officially released system is optimized for operation efficiency of the mobile terminals to provide good compatibility for the software and hardware, thereby stabilizing the system operation and providing better security. When modifying the officially released system by way of rooting, the software will be modified typically, which may easily result in incompatibility between the software and hardware, and cause the mobile terminal unable to function properly, and even unable to be restarted. Thus, once the officially released system in the mobile terminal is modified, the manufacturer of the mobile terminal often spends lots of time and efforts to determine the real cause of the handset malfunction when the mobile terminal breaks down. As a consequence, identifying whether the system on the mobile terminal is the officially released system is beneficial for maintaining a malfunctioned handset quickly and effectively.

Further, some manufacturers of mobile terminals regard the malfunction due to modification to the officially released system as a failure due to human factor rather than the qualities of the mobile terminals. Subsequently the warranties of the manufacturers do not cover such a mobile terminal failure. In other words, a handset failure occurs after an officially released system is modified usually is not covered by the warranty. In this situation, the manufacturer of the mobile terminals may quickly determine whether the warranty covers the breakdown of the mobile terminals by identifying whether the system on the mobile terminal is the officially released system.

Therefore, a detection method is needed in the present technology to effectively determine whether a system on a mobile terminal is official, since it is complicated to determine whether a system on a mobile terminal is official in the conventional approach, which may result in a misinterpretation of a malfunction on the mobile terminal and the warranty thereof.

### BRIEF SUMMARY OF THE INVENTION

A detailed description is given in the following embodiments with reference to the accompanying drawings.

An embodiment of a detection method is described, adopted by a mobile terminal, comprising: receiving a test instruction; acquiring current storage integrity information of the mobile terminal according to the test instruction; matching the current storage integrity information to original storage integrity information; and outputting information indicating that a current system on the mobile terminal is an incomplete system when the matching fails.

The step of acquiring current storage integrity information of the mobile terminal comprises: acquiring current system file information of system partitions of the mobile terminal, and/or an information quantity of the current system file information of the system partitions of the mobile terminal to acquire the current storage integrity information of the mobile terminal. The step of matching the current storage integrity information to the original storage integrity information comprises: comparing the current system file information to original system file information, and/or determining whether the information quantity of the current system file information is consistent with that of the original system file information, and/or when the information quantity of the current system file information is inconsistent with that of the original system file information, determining that the matching of the current storage integrity information and original storage integrity information fails.

the step of comparing the current system file information to the original system file information comprises: comparing a storage path and a file name of a current system file to those of an original system file; when the storage paths and the file names of the current system file and the original system file are not matched, determining that the matching of the current storage integrity information and original storage integrity information fails; and when the storage paths and the file names of the current system file and the original system file are matched, calculating a checksum of the current system file according to information in the current system file, determining whether the calculated checksum is identical to a checksum of the original system file, and when determining the calculated checksum is different from the checksum of the original system file, determining that the matching of the current storage integrity information and original storage integrity information fails.

The step of comparing the storage path and the file name of the current system file to those of the original system file comprises: when the storage paths and the file names of the current system file and the original system file are not matched, indicating additional system file information of the system partitions, and outputting the information indicating that the current system on the mobile terminal is an incomplete system; and when determining the calculated checksum is different from the checksum of the original system file, indicating information that contents of the current system file and the original system file are inconsistent, and outputting the information indicating that the current system on the mobile terminal is an incomplete system.

After the step of comparing the current system file information to the original system file information, the detection method further comprises: when the storage paths and the file names of the current system file and the original system file are matched, marking the storage path and the file name of the original system file. The step of outputting the information indicating that the current system on the mobile terminal is an incomplete system comprises: acquiring an unmarked storage path and file name among all storage paths and file names of the original file system, and indicating the unmarked storage path and file name to indicate original system files corresponding to the unmarked storage path and file name and output the information indicating that the current system on the mobile terminal is an incomplete system.

The step of acquiring the current storage integrity information of the mobile terminal comprises: calculating a checksum of current storage data of another partition to acquire the current storage integrity information of the mobile terminal, the another partition is a partition other than the system partition. The step of matching the current storage integrity information to the original storage integrity information comprises: comparing the checksum of the current storage data of the another partition and a checksum of original storage data; when the checksum of the current storage data of the another partition and the checksum of the original storage data are inconsistent, determining that the matching of the current storage integrity information and original storage integrity information fails. The step of outputting the information indicating that the current system on the mobile terminal is an incomplete system comprises: indicating information about content of the current storage data corresponding to the another partition has been modified to output the information indicating that the current system on the mobile terminal is an incomplete system.

The step of matching the current storage integrity information to the original storage integrity information comprises: acquiring the original storage integrity information from predetermined storage area of the mobile terminal; and matching the current storage integrity information to the acquired original storage integrity information.

The step of acquiring the current storage integrity information of the mobile terminal comprises: acquiring an encrypted file containing the original storage integrity information from the predetermined storage area of the mobile terminal; and decoding the encrypted file to acquire the original storage integrity information.

The original storage integrity information storage integrity information of the mobile terminal are generated by acquiring original information associated with storage integrity of the mobile terminal before the mobile terminal is shipped out from a factory, and are stored in the predetermined storage area in a form of the encrypted file. The current storage integrity information are information associated with current storage integrity of the mobile terminal before the mobile terminal is shipped out from the factory.

The original information associated with storage integrity of the mobile terminal include original system file information of system partitions of the mobile terminal, and the original system file information including at least a storage path, a file name and a checksum of a system file; and/or the original information associated with storage integrity of the mobile terminal include at least a checksum of original storage data of another partition; and the checksum of the original storage data of the another partition is calculated by storage data in the another partition other than the system partition.

The step of receiving the test instruction comprises: receiving a predefined key instruction during power-on to enter an engineering mode based on the predefined key instruction; and receiving a selection instruction which selects from a function menu for checking system integrity to receive the test instruction.

Another embodiment of a mobile terminal is disclosed, comprising a first reception module, a first acquisition module, a matching module and an output module. The first reception module is configured to receive a test instruction. The first acquisition module is configured to acquire current storage integrity information of the mobile terminal according to the test instruction. The matching module is configured to match the current storage integrity information to original storage integrity information. The output module is configured to output information indicating that a current system on the mobile terminal is an incomplete system when the matching fails.

The first acquisition module acquires current system file information of system partitions of the mobile terminal, and/or an information quantity of the current system file information of the system partitions of the mobile terminal to acquire the current storage integrity information of the mobile terminal. The matching module compares the current system file information to original system file information, and/or determines whether the information quantity of the current system file information is consistent with that of the original system file information, and/or when the information quantity of the current system file information is inconsistent with that of the original system file information, determines that the matching of the current storage integrity information and original storage integrity information fails.

The matching module comprises: a comparison unit, comparing a storage path and a file name of a current system file to those of an original system file, when the storage paths and the file names of the current system file and the original system file are not matched, determining that the matching of the current storage integrity information and original storage integrity information fails; a first calculation unit and a first determination unit; wherein when the storage paths and the file names of the current system file and the original system file are matched, the first calculation unit calculates a checksum of the current system file according to information in the current system file; and the first determination unit determines whether the calculated checksum is identical to a checksum of the original system file, and when determining the calculated checksum is different from the checksum of the original system file, determines that the matching of the current storage integrity information and original storage integrity information fails.

The output module comprises a display unit, when the storage paths and the file names of the current system file and the original system file are not matched, displaying additional system file information of the system partitions to output the information indicating that the current system on the mobile terminal is an incomplete system; and when determining the calculated checksum is different from the checksum of the original system file, displaying information that contents of the current system file and the original system file are inconsistent to output the information indicating that the current system on the mobile terminal is an incomplete system.

The mobile terminal further comprises a marking unit, when the storage paths and the file names of the current system file and the original system file are matched, marking the storage path and the file name of the original system file; wherein the output module comprises a first acquisition unit and a display unit; the first acquisition unit acquires an unmarked storage path and file name among all storage paths and file names of the original file system, and the display unit displaying the unmarked storage path and file name to indicate original system files corresponding to the unmarked storage path and file name to output the information indicating that the current system on the mobile terminal is an incomplete system.

The matching module calculates a checksum of current storage data of another partition to acquire the current storage integrity information of the mobile terminal, wherein the another partition is a partition other than the system partition. The matching module compares the checksum of the current storage data of the another partition and a checksum of original storage data, and when the checksum of the current storage data of the another partition and the checksum of the original storage data are inconsistent, determines that the matching of the current storage integrity information and original storage integrity information fails. The output module displays information about content of the current storage data corresponding to the another partition has been modified to output the information indicating that the current system on the mobile terminal is an incomplete system.

The second acquisition unit acquires the original storage integrity information from predetermined storage area of the mobile terminal. The matching unit matches the current storage integrity information to the acquired original storage integrity information.

The second acquisition unit includes an acquisition sub-unit and a disruption sub-unit. The acquisition sub-unit acquires an encrypted file containing the original storage integrity information from the predetermined storage area of the mobile terminal. The disruption sub-unit decodes the encrypted file to acquire the original storage integrity information.

The mobile terminal further comprises a second acquisition module, acquiring original information associated with storage integrity of the mobile terminal before the mobile terminal is shipped out from a factory to generate the original storage integrity information of the mobile terminal; and a storage module, storing in the predetermined storage area in a form of the encrypted file; and wherein the current storage integrity information is information associated with current storage integrity of the mobile terminal before the mobile terminal is shipped out from the factory.

The second acquisition module acquires the original system file information of the system partition of the mobile terminal to acquire the storage integrity of the mobile terminal, and the original system file information including at least a storage path, a file name and a checksum of a system file; and/or the original information associated with storage integrity of the mobile terminal include at least a checksum of original storage data of another partition; and the checksum of the original storage data of the another partition is calculated by storage data in the another partition other than the system partition.

The mobile terminal further comprises a second reception module, receiving a predefined key instruction during power-on to enter an engineering mode based on the predefined key instruction, and wherein the first reception module receives a selection instruction which selects from a function menu for checking system integrity to receive the test instruction.

The benefits of the embodiments according to the invention include: the system information stored in the mobile terminal are changed after the original system of the mobile terminal is modified. Once the system information is modified, then the data stored in the mobile terminal are no longer the complete storage information corresponding to the original system. Therefore, the embodiments in the present invention match the current storage integrity information to the original storage integrity information, and when the matching fails, inform that the storage integrity information in the mobile terminal is modified and no longer the original storage integrity information and the current system on the mobile terminal is no longer the original system, and the current system on the mobile terminal contains incomplete system information, thus a test personnel may identify that the original system on the mobile terminal has been modified and no longer the official system according to the output result, thereby accurately determining the warranty of the mobile terminal.

### BRIEF DESCRIPTION OF THE DRAWINGS

The present invention can be more fully understood by reading the subsequent detailed description and examples with references made to the accompanying drawings, wherein:

FIG. 1 shows a detection method adopted by a mobile terminal according to an embodiment of the invention;

FIG. 2 is a flowchart of a detection method before a mobile terminal receives a test instruction according to an embodiment of the invention;

FIG. 3 is a flowchart of a method for acquiring the original storage integrity information from the predetermined storage area of the mobile terminal according to an embodiment of the invention;

FIG. 4 is a flowchart of a method for receiving a test instruction according to an embodiment of the invention;

FIG. 5 is a block diagram of a mobile terminal according to an embodiment of the invention;

FIG. 6 is a block diagram of a mobile terminal according to another embodiment of the invention;

FIG. 7 is a block diagram of a mobile terminal according to yet another embodiment of the invention;

FIG. 8 is a block diagram of a mobile terminal according to still another embodiment of the invention; and

FIG. 9 is a block diagram of a mobile terminal according to still another embodiment of the invention.

### DETAILED DESCRIPTION OF THE INVENTION

Various aspects are described here in connection with detection methods for mobile terminals to check system integrity thereof, in particular, to a complete system check after a mobile terminal is shipped out from the factory. The system integrity described herein is in relation to an original system, or an official system of the mobile terminal. When the current system of the mobile terminal is still the official system, the system running on the mobile terminal has never been modified by any unofficial means and turned into a personalized system, the current system on the mobile terminal is complete, wherein the modification to the system includes rooting, system upgrading, and so on, and consequently. When the current system on the mobile terminal is modified by an unofficial means and no longer the officially released system, the current system on the mobile terminal is incomplete. Checking the system integrity of the mobile terminal is about to check whether the current system on the mobile terminal has been modified and is no longer the official system, thereby providing a system diagnosis when the mobile terminal malfunctions, which is beneficial to the maintenance of the mobile terminal, and serving as a reference as to determine whether the malfunctioned mobile terminal is still under the warranty.

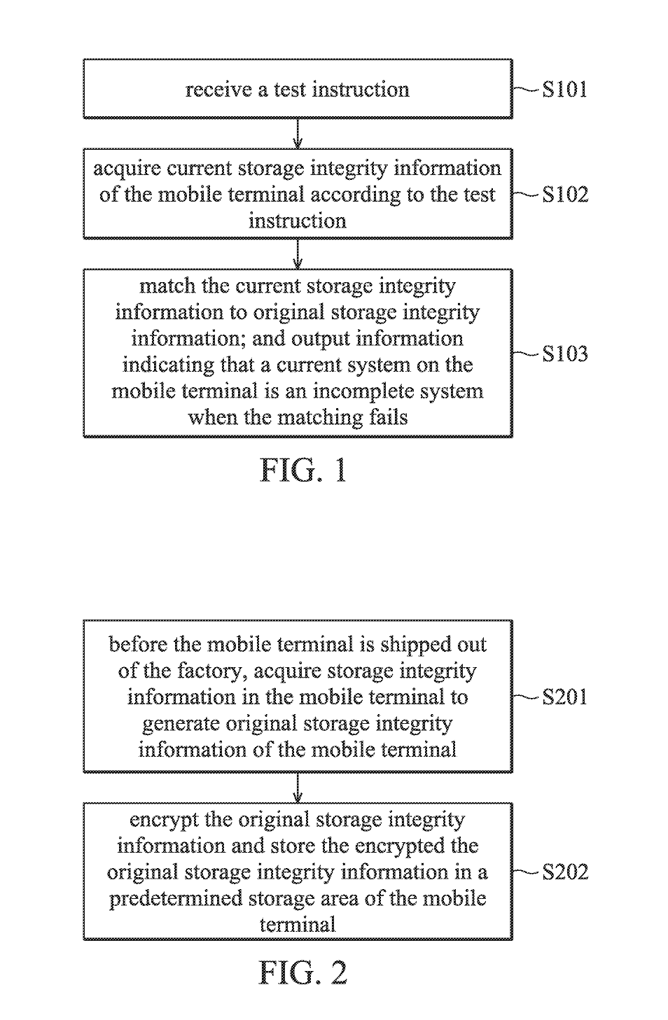

Referring to FIG. 1, which shows a detection method adopted by a mobile terminal according to an embodiment of the invention. The detection method includes the following steps:

Step S101: receive a test instruction.

When it is required to perform a check for the mobile terminal, a test instruction is entered into the mobile terminal to trigger the detection procedure.

Step S102: acquire current storage integrity information of the mobile terminal according to the test instruction.

Upon receiving the test instruction, the mobile terminal starts performing the detection procedure. First, current storage integrity information of the mobile terminal are acquired. The current storage integrity information indicates whether the data stored in the mobile terminal are the complete information. When the current system on the mobile terminal is the original system, the data stored in the mobile terminal are the complete information; whereas when the current system on the mobile terminal is not the original system, the data stored in the mobile terminal are the incomplete information. The original system is also known as the official system, which may be the official system installed on the mobile phone when it is shipped out from the factory, or the updated official system after it is shipped out from the factory. The current storage integrity information is the information associated with the storage integrity information of the current system.

Specifically, the current storage integrity information is system file information about the system partition or file information of other partitions, and may be system version information, a system created time, and so on.

Step S103: match the current storage integrity information to original storage integrity information; and output information indicating that a current system on the mobile terminal is an incomplete system when the matching fails.

The original storage integrity information is the information associated with the storage integrity information of the original system. The current storage integrity information is matched to the original storage integrity information, when the matching is successful, which means the current storage integrity information is consistent with the original storage integrity information, indicating that the information currently stored in the mobile terminal is the complete information. Since the current system on the mobile terminal is the original system, the mobile terminal will output information that the currently stored information on the mobile terminal is the complete information. When the matching fails, which means the current storage integrity information is inconsistent with the original storage integrity information, indicating that the information currently stored in the mobile terminal is an incomplete system, and the current system on the mobile terminal is not the original system, but a modified system. Since the current system on the mobile terminal is an incomplete system, the mobile terminal will output information indicating the currently stored information on the mobile terminal is an incomplete system. The information can serve as a reference for malfunction maintenance of the mobile terminal, and can be used to determine whether the mobile terminal is still within the coverage of the warranty.

The original storage integrity information is stored in the mobile terminal in advance. In one embodiment, the original system is the official system on the mobile terminal before it is shipped out of the factory, and is the information associated with the storage integrity before it is shipped out of the factory. In the present embodiment, the original storage integrity information is stored in the mobile terminal before being shipped out from the factory, and serves as an original comparison reference for the detection procedure after the mobile terminal is shipped out. In particularly, in one embodiment as shown in FIG. 2, the following steps are performed before the mobile terminal receives the test instruction:

Step S201: before the mobile terminal is shipped out of the factory, acquire storage integrity information in the mobile terminal to generate original storage integrity information of the mobile terminal.

After the mobile terminal is manufactured, the mobile terminal can acquire the original storage integrity information before being shipped out. Specifically, the original storage integrity information may be the system file information about the system partition or file information of other partitions before the mobile terminal is shipped out, and may be system version information, a system created time, or a derivative thereof. The original storage integrity information includes at least a storage path, a file name and a checksum of a system file, and the file information of the other partitions include checksums of the original storage data of the other partitions, which are calculated based on the storage data of the other partitions. The current storage integrity information is the storage integrity information after the mobile terminal is shipped out from the factory. Specifically, the current storage integrity information may be the system file information about the system partition or file information of other partitions after being shipped out. In other words, the original storage integrity information is generated based on the original information associated with the storage integrity of the mobile terminal before the mobile terminal is shipped out, and is encrypted and then stored in a predetermined storage area; whereas the current storage integrity information is the current information associated with the storage integrity of the mobile terminal after it is shipped out from the factory.

Step S202: encrypt the original storage integrity information and store the encrypted the original storage integrity information in the predetermined storage area of the mobile terminal.

In particular, after the mobile terminal acquires the original storage integrity information, it can record the original storage integrity information into a file such as a text file or an excel table, and encrypt the file after recording, thereby generating an encrypted file which records the original storage integrity information. The encrypted file serves as a database storing the original storage integrity information. Moreover, the encrypted file may be compressed and then be stores into the predetermined storage area, which may be configured as a read-only area to prevent the encrypted file from being illegitimately modified.

The original storage integrity information may be stored in the form of a encrypted file to prevent the original storage integrity information from being illegitimately modified, and can provide the accurate original storage integrity information for the subsequent information matching procedure and ensure the accuracy of the detection result. In other embodiments, the original storage integrity information may be the storage integrity information pre-stored in the mobile terminal after the mobile terminal is shipped out from the factory and before the detection procedure starts.

In an optional embodiment, the original storage integrity information may not be acquired by the mobile terminal, but may be acquired by a system management tool. For example, the original storage integrity information may be acquired by a system management tool before the mobile terminal is shipped out, which is subsequently encrypted to generate the encrypted file of the original storage integrity information, and then is stored into the predetermined storage area of the mobile terminal.

Furthermore, the predetermined storage area may be a recovery sub-area in the mobile terminal. The recovery sub-area is a crucial part in the detection procedure of the embodiment, and can impact on the accuracy of the detection result. If the original storage integrity information in the recovery sub-area is modified illegitimately, the reference information used in the detection procedure will be incorrect, resulting in an invalid detection. Therefore, in order to ensure the accuracy of the detection result and prevent from using an incorrect reference information (the original storage integrity information) in the subsequent detection procedure, in a preferred embodiment, a timestamp is set for the encrypted file which is used for recording the original storage integrity information, by which a test personnel can identify whether the encrypted file is modified based on the timestamp of the encrypted file, thereby determining whether the encrypted file is correct and deciding on whether the subsequent detection procedure should be continued.

The timestamp of the encrypted file is used to record the time when the encrypted file is inserted or updated. Before the mobile terminal is shipped out from the factory and after the original storage integrity information is added into the encrypted file, the timestamp records the original written time and column location for each column of data in the encrypted file, and each column corresponds to one timestamp. Before the mobile terminal is shipped out from the factory, the original written time of all timestamps of the encrypted file may be configured to be consistent with one another. After the mobile terminal is shipped out from the factory, if the encrypted file is modified illegitimately, e.g., a line of information in the encrypted file is modified, then the timestamp corresponds to the line of information will be changed and original written time will be updated to the modified time. In another example, when a line of information is added to the encrypted file, a timestamp will be added into the encrypted file accordingly, to record a written time and a number of the added lines. Thus before the test instruction is entered into the mobile terminal, a test personnel may enter a timestamp test instruction to make the mobile terminal output the timestamp of the encrypted file, and consequently, the test personnel may identify whether the data in the encrypted file is modified according to the output timestamp of the encrypted file. For instance, when a timestamp of a line shows that the written time of the line is not the original written time, which means that the line of information has been updated and modified, thus the test personnel may determine that the content of the encrypted file has been modified and the original storage integrity information may not be correct. The result can be used as a reference to determine whether a detection procedure should be performed for the mobile terminal, in order to ensure the accuracy of the subsequent detection result.

After the mobile terminal receives the test instruction, a detection procedure will start. Specifically, the current storage integrity information can be acquired based on the test instruction, the original storage integrity information can be acquired from the predetermined storage area in the mobile terminal, and then the current storage integrity information is compared to the original storage integrity information.

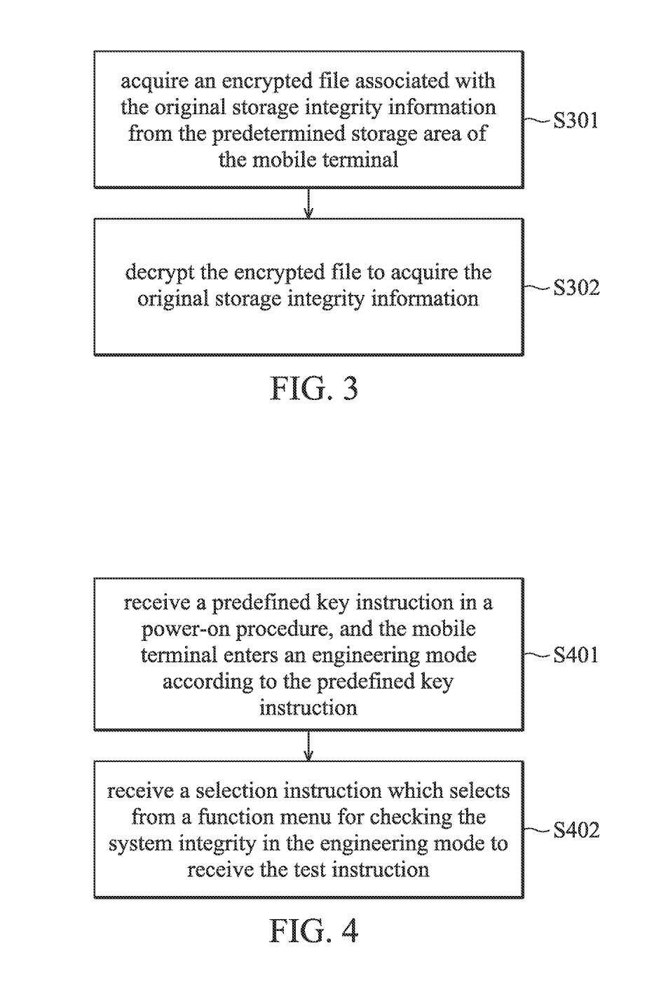

Further, since the original storage integrity information is stored in the predetermined storage area in the form of the encrypted file, it can be acquired from the predetermined storage area of the mobile terminal by following steps, as depicted in FIG. 3.

Step S301: acquire an encrypted file used for recording the original storage integrity information from the predetermined storage area of the mobile terminal.

The encrypted file is stored in the predetermined storage area in the form of a compressed file, therefore, firstly, the compressed file is obtained from the predetermined storage area, and then the compressed file is decompressed to retrieve encrypted file which records the original storage integrity information.

Step S302: decrypt the encrypted file to acquire the original storage integrity information.

Accordingly, the original storage integrity information can be obtained from the predetermined storage area. Before the mobile terminal is shipped out, the mobile terminal manufacturer may pre-store the original storage integrity information of the mobile terminal into the predetermined storage area, so that when the mobile terminal breaks down after being shipped out, a detection procedure can be used to determine that whether the current storage integrity information is the original storage integrity information of the mobile terminal. Consequently, it can be identified that whether the current system is the original system (i.e., official system) on the mobile terminal according to the detection result, which is a reference for determining whether the mobile terminal is under the warranty.

In a preferred embodiment, the original storage integrity information is the original system file information of the system partition before shipped out. Therefore, in Step S201, the step of before the mobile terminal is shipped out of the factory, acquiring storage integrity information in the mobile terminal to generate original storage integrity information of the mobile terminal further includes: before the mobile terminal is shipped out of the factory, obtain the original system file of the system partition on the mobile terminal to acquire the storage integrity information of the mobile terminal, wherein the original system file is file information of the original system file, and the original system file is the system file of the system partition before the mobile terminal is shipped out, the file information of the original system file includes a storage path, a file name, a file content, a creation time, and a file summary, etc. Step S202 may be implemented by: storing the original system file information into the predetermined storage area in the form of an encrypted file, wherein each original system file information corresponds to one original system file, and each original system file information is recorded in the encrypted file.

In the embodiment, when a detection for the mobile terminal is required after the mobile terminal is shipped out, the current storage integrity information which the mobile terminal acquires based on the test instruction is the current system file information (ie. the file information of the current system file). Any modification to the file information of the system file is a modification to the system. In the embodiment, the file information of the system file of the current system is checked to determine whether the current system is still the original system, thereby determining whether the current system is a complete system. The file information of the system file of the original system is adopted as a reference for determining that whether the file information of the system file of the current system has been modified. When information of the system file of the current system is no longer file information of the system file of the original system, the file information of the system file of the current system is determined to have been changed.

In particular to the present embodiment, the step of acquiring the current storage integrity information of the mobile terminal can be implemented by: obtaining the current system file information of the system partition of the mobile terminal to acquire the current storage integrity information of the mobile terminal. The system partition is a partition carrying a system file, serving as a storage area for storing the system file. The current system file information is the file information of the system file of the current system on the mobile terminal, i.e., the file system of the current system file, and includes information such as a storage path, file name, file content, created time, and file summary, wherein the current system file is the system file in the system partition of the mobile terminal when the detection procedure is performed on the mobile terminal after it is shipped out.

When the system is modified, the associating system file will be modified too. For example, when an icon on the system desktop is modified, a graphic file which serves as one of the system files will also be modified, the information such as an image or text stored in the graphic file will be replaced by a new image or text. Hence, the modification to the system file is an important reference for determining whether the system file has been changed.

The step of comparing the current storage integrity information to original storage integrity information can be implemented by: comparing the current system file information with the original system file information. The original system file information is the information pre-stored in the predetermined storage area before the mobile terminal is shipped out. Step S301 may include: acquiring the encrypted file which records the original system file information from the predetermined storage area. Step S302 may include: decrypting the encrypted file to acquire the original system file information.

The system files are in large quantities, each system file corresponds to file information. The comparison procedure may include: each time when current system file information is acquired, the acquired current system file information is compared to all original system file information to receive one among all original system file information which is identical to the current system file information. When the current system file information is not found from all original system file information, the system file corresponding to the current system file information may be a newly added, or modified from the original system file, and the current system is no longer a complete system. As a result, it can be determined that comparing of the current storage integrity information and the original storage integrity information fails. It should be noted that the current system file is a newly added system file with reference to the original system files or the official system files.

When the matching is determined as failure, the current information stored on the mobile terminal is determined an incomplete information, and the current system is no longer the original system or the complete system, subsequently, the information indicating that the current system on the mobile terminal is incomplete is output as the detection result. In some embodiments, a screen on the mobile terminal may show the information that the current system file information is not found among the original system file information. For example, when the system file information of a system file A is not found from the original system file information, the information of “An system file A is newly added to the current system” may be displayed. In other embodiments, the detection result may be displayed on a designated display device by means of wired or wireless communications, or transmitted to another equipment such as a printer for outputting the detection result. Therefore, the test personnel may identify that the current system on the mobile terminal is no longer the original system but a modified system based on the detection result, thereby providing a system diagnosis reference for the malfunction of the mobile terminal, or as a determination reference for determining whether the mobile terminal is still under the warranty.

Moreover, when all current system file information are found in the original current system file information, it indicates that no new system is added or the original system files are not modified. Thus, an information quantity of the current system file information will be calculated, and then whether the information quantity of the current system file information is consistent with that of the original system file information will be determined. When they are inconsistent or when the information quantity of the current system file information is less than that of the original system file information, there is a shortage in the current system files. In this situation, the matching between the current storage integrity information and the original storage integrity information is determined unsuccessful, the current storage integrity information on the mobile terminal is incomplete and the system is no longer the original system or a complete system. The information indicating that the current system is an incomplete system is output. In practice, the information of “A shortage in the system files of the current system is identified” may be displayed on the screen of the mobile terminal, and as a consequence, the test personnel may know that the current system has been modified and no longer is the original system based on the displayed information, and can determine whether the mobile terminal is still under the warranty.

The output detection result may also directly show that the system is complete or incomplete. For instance, when the current storage integrity information does not match the original storage integrity information, the information “the current system is incomplete” may be displayed directly as the output detection result; whereas when the current storage integrity information matches the original storage integrity information, the information “the current system is complete” may be displayed directly.

In a preferred embodiment, the original system file information includes a storage path, a file name, and a checksum. In other words, each original system file information records a storage path, a file name, and a checksum of an original system file correspondingly. In another embodiment, the original system file information may also include additional information such as a summary and a modification time of the original system file.

In the embodiment, the step of acquiring the original system file information of the system partition on the mobile terminal before it is shipped out may be implemented by: acquiring the storage path, the file name, and the checksum from the original system file to obtain the original system file information, whereby acquiring the original storage integrity information. The checksum of the original system file correlates to the content of the original system file. The checksum of the original system file may be calculated by a Cyclic Redundancy Check (CRC) algorithm based on the content of the original system file to ensure the accuracy of the recorded content of the original system file. In a preferred embodiment, the CRC32 algorithm is adopted for calculating the checksum of the original system file. In another embodiment, the CRC16 algorithm is adopted to perform the calculation. Further, in yet another embodiment, the Message-Digest (MD) algorithm is adopted to calculate the checksum of the original system file, e.g., various versions of the MD algorithm such as MD4 or MD5 are adopted to calculate the checksum. The storage path, the file name, and the checksum of the original system file are stored in the encrypted form into the predetermined storage area.

When the system is modified, the storage path, the file name, and the checksum of the corresponding system file are varied accordingly. Thus whether the current system is the original system primarily is determined based on the storage path, the file name, and the checksum. Specifically, the step of comparing the current storage integrity information to the original storage integrity information may be implemented by: comparing the storage path and the file name of the current system file with those of the original system file.

After receiving the test instruction, the mobile terminal acquires the storage path and the file name of the current system file based on the test instruction, and acquires the storage path and the file name of the original system file from the predetermined storage area. In the comparison step, each time when the storage path and the file name of one current system file are retrieved, the mobile terminal may compare the storage path and the file name of the current system file with those of all original system files, thereby querying and acquiring the storage path and the file name of the original system file, which are identical to those of the current system file.

When one of the storage path and the file name of the current system file is unable to be found from the storage paths and the file names of the original system files, the current system file may be a newly added system, or a modified system file from the original system file. The current system has already been modified and is no longer the original system, and the current storage integrity information is determined to be unmatched the original storage integrity information, and the information indicating that the current system is incomplete is output. When outputting the detection result, the information that a new system file is added to the system partition is displayed. In particular, the storage path and the file name of the current system file along with no match can be found for the current system file can be displayed. For example, when the storage path and the file name of a system file A cannot be found from the storage path and the file name of the original system file, the displayed detection result may be “system file A in directory xxx\xxx\xxx not found”, where “A” represents the file name including the file type, “xxx\xxx\xxx” represents the storage path of the system file A. It may also display the content of the system file A newly added to the system partition. For example, the displayed detection result may be “system file A in directory xxx\xxx\xxx is newly added to the current system”, assisting the test personnel to understand the present condition of the system and serving as a reference for maintenance of the mobile terminal. In another embodiment, the detection result is redirected to another equipment for display, or sent to a printer equipment for printing out.

When the storage path and the file name of the current system file cannot be found from the storage paths and the file names of the original system files, the current system file has been modified and is no longer the original system file. Therefore the current system file is no longer the original system, and the detection result may serve as a reference for the malfunction diagnosis, or may be used to determine whether the mobile terminal is still under the warranty. At this point, it is not required to compare the checksum of the current file system, i.e., checking the content of the current file system is unnecessary, and the detection time can be reduced.

When one of the storage path and the file name of the current system file cannot be found from the storage paths and the file names of the original system files, after outputting the detection result that the current file is incomplete, the mobile terminal may in turn continue comparisons for the remaining storage paths and the file names of the current system files to provide more understanding about the current system to the test personnel. In another embodiment, the detection procedure is ended to save the detection time.

When one of the storage path and the file name of the current system file is found from the storage paths and the file names of the original system files, the current system file is present in the original system files, i.e., the original system files contain the system file with the storage path and the file name identical to those of the current file system. Subsequently it should be determines whether the content of the current system file is identical to that of the corresponding original system file, wherein the corresponding original system file has the identical storage path and the file name as those of the current system file. In particular, the checksum of the current system file is calculated according to the data stored in the current system file, e.g., using the CRC32 algorithm or the MD5 algorithm. Next, the calculated checksum of the current system file is compared to that of the corresponding original system file to determine whether the content of the current system file is the same as that of corresponding original system file.

When the calculated checksum of the current system file is the same as that of the corresponding original system file, the content of the current system file is the same as that of the corresponding original system file, thus the current system file has not been modified, and then the comparison procedure is performed to the next current system file. When the calculated checksum of the current system file is different from that of the corresponding original system file, the content of the current system file is different from that of the corresponding original system file, thus the current system file has been modified and is no longer the original system file, and the current system is no longer the original system, the matching between the current storage integrity information and the original storage integrity information is unsuccessful, and the information that the current system is incomplete is output. The calculated checksum of the current system file is inconsistent with that of the corresponding original system file may be displayed directly on the screen of the mobile terminal to output the information that the current system is incomplete.

For example, when the calculated checksum of a system file A in the current system files is different from that of the corresponding original system file, the detection result of “the content in the system file A in directory xxx\xxx\xxx does not match that in the current system” may be displayed on the screen of the mobile terminal. Thus, the detection personnel may identify that the current system on the mobile terminal is no longer the original system but a modified system based on the detection result, thereby obtaining a system diagnosis reference for the malfunction of the mobile terminal, or as a determination reference for determining whether the mobile terminal is still under the warranty.

In addition, when the calculated checksum of a system file A in the current system files is different from that of the corresponding original system file, after the detection result is output, the mobile terminal may in turn continue comparisons for the remaining current system files to provide more understanding about the current system to the test personnel. In another embodiment, the detection procedure is ended to save the detection time.

In another embodiment, the detection method may detect the absent current system files in the system partition. Specifically, after comparing the current storage integrity information and the original storage integrity information, when the storage path and the file name of the current system file is found from the storage paths and the file names of the original system files, the corresponding storage path and the file name of the original system file will be marked.

When one of the storage path and the file name of the current system file is found from the storage paths and the file names of the original system files, the current system file is present in the original system files, that is, the original system files contains an original system file identical to the current system file, thus the storage path and the file name of the original system file will be marked. In particular, the encrypted file information of the original system file is marked to represent that the original system file exists in the current system. After all current system files are compared to the original system files, the unmarked storage path and the file name of the original system file are acquired. When at least one unmarked storage path and the file name of the original system file is retrieved, the unmarked storage path and the file name of the original system file are absent from the current system files, i.e., the original system file with the unmarked storage path and the file name is absent from the current system, and consequently, the step of outputting the information that the current system on the mobile terminal is incomplete includes: displaying the unmarked storage path and file name to indicate that the current system files lack the information of the storage path and file name unmarked in the original system files.

For instance, after the comparison procedure is performed to all current system files, the unmarked storage path and the file name of system file B in the original system file are acquired, the following detection result may be displayed: “system file B is missed from the current system files in directory xxx\xxx\xxx”, where “B” represents the file name including the file type, “xxx\xxx\xxx” represents the storage path of the system file B. This can serve as a system diagnosis reference for the malfunction of the mobile terminal, and is useful for the maintenance of the mobile terminal. Also, it may be determined whether the current system on the mobile terminal is complete or not based on the detection result, thereby providing a system diagnosis reference for the malfunction of the mobile terminal or as a determination reference for determining whether the mobile terminal is still under the warranty.

When all current system file information is consistent with the original system file information, the current system contains the complete information, wherein all current system file information includes the storage paths, file names and checksums, and the quantities of the current system file information.

In this embodiment, the original storage integrity information is the original system file information. The detection method can determine whether the current system on the mobile terminal is complete or not by comparing the current system file information to the original system file information. In another embodiment, the system file information are not compared, but the detection method determines whether the current system on the mobile terminal is complete by comparing the information quantities. The storage integrity information is the information quantity of the system file information.

The original storage integrity information is the information quantity of the original system file information, the detection method determines whether the current system on the mobile terminal is complete by comparing the information quantities of the current system file information and those of the original system file information. Specifically, when the mobile terminal receives the test instruction, the information quantity of the current system file information can be acquired according to the test instruction to obtain the current storage integrity information of the mobile terminal. Each current system file corresponds a current system information, thus the information quantity of the current system file information is the file quantity of the current system files. The information quantity of the current system file information is acquired by acquiring the file quantity of the current system files.

The step of matching the current storage integrity information to the original storage integrity information includes: determining whether the information quantities of the current system file information are consistent to those of the original system file information. The information quantity of the original system file information is the quantity of the original system file information recorded in the encrypted file. When the information quantities between the current system file information and the original system file information are inconsistent, indicating a change of the current system files, and the current system is no longer the original system or the complete system. The information that the current system is incomplete is output. When the information quantities of the current system file information are consistent to those of the original system file information, the current system is not modified and is still the original system, and the information that the current system is complete is displayed.

It is highly probable that a file has been added to or deleted from the system files when the system is modified, in such a case, it is determined whether the current system file is modified by directly comparing the information quantities, thereby it is determined whether the current system on the mobile terminal is complete. An easier and simpler detection procedure is provided.

In order to ensure the accuracy of the detection result, when the information quantities between the current system file information and the original system file information are consistent, the system file information may then be compared. That is, the current system file information is compared to the original system file information. The implementation may be realized by the preceding embodiments, description therefore is omitted here for brevity.

The present embodiment is different from the preceding embodiment in that after receiving the test instruction, the information quantities of the system file information are compared. When the information quantities of the current system file information and the original system file information are inconsistent, it can be determined that the current system is incomplete without performing further comparison for the system file information. Therefore the detection procedure becomes simpler.

In various preceding embodiments, the storage integrity information is the system file information and the information quantity in the system partition. In yet another embodiment, the storage integrity information may also be the content in the other partition, and specifically, it may be the checksum of the content in the other partition.

The embodiment determines whether the current system on the mobile terminal is complete based on the content stored in the other partition. The other partition is a partition other than the system partition, and does not contain the system file. The other partition includes, such as, a 1 k partition, a recovery partition, a boot partition and a logo partition. The original storage integrity information includes the checksum of the original storage data in the other partition. Each of the other partitions corresponds to a checksum of the original storage data. The original storage integrity information includes the checksums of the original storage data in all the other partitions. The original storage data in all the other partitions are data stored before the mobile terminal is shipped out, which include the data in all files of the partitions. Therefore, the original storage integrity information are the checksums of the data stored in other partitions before the mobile terminal is shipped out, the checksums are calculated based on all the data stored in the corresponding other partitions. So, the checksum of the original storage data in each other partition represents all the data stored in the corresponding other partition before the mobile terminal is shipped out. In the embodiment, the step of implementing Step S201 includes: calculating the checksums of the original storage data in the other partitions based on the storage data in the other partitions other than the system partition in the mobile terminal to acquire the original storage integrity information. The step of implementing Step S202 includes: storing the checksum of the original storage data in the other partitions in the encrypted form to the predetermined storage area, to provide the original reference information for the subsequent detection procedure.

When a detection is performed to the mobile terminal after the test instruction is received, the step of acquiring the current storage integrity information includes: calculating the checksums of the current storage data of the other partitions of the mobile terminal to acquire the current storage integrity information of the mobile terminal. The current storage integrity information is the checksum of the current storage data in all other partitions, wherein each of the other partitions corresponds to a checksum of the current storage data. Specifically, the CRC32 algorithm or the MD5 algorithm is used to obtain the checksum of the current storage data of the other partitions. The current storage data of the other partitions refers to the data currently stored in the other partitions, including the content of all files in the partition.

The step of matching the current storage integrity information to the original storage integrity information includes: comparing the checksums of the current storage data of the other partitions to the checksums of the original storage data. Whenever a checksum of the current storage data of the other partitions is calculated, then the calculated checksum of the current storage data is compared to that of the original storage data of the other partitions to determine whether the checksums of the current storage data and the original storage data are the same. When the checksums of the current storage data and the original storage data are the same, the current storage data is consistent with the original storage data of the other partition, the stored content has not been modified, thus the detection procedure proceeds to the next partition. When the checksums between the current storage data and the original storage data are the different, the current storage data is different from the original storage data of the other partition, and the stored content has been modified. As a consequence, the matching between the current storage integrity information and the original storage integrity information is determined as unsuccessful, the current stored information on the mobile terminal is incomplete, and the current system on the mobile terminal is no longer the original system. At this point, the step of outputting the information that the incomplete system is on the mobile terminal includes: displaying the information that the content in the other partition has been modified. For example, when the checksums of the current storage data in the 1 k partition and those of the original storage data are inconsistent, the following detection result may be displayed: “the content of the 1 k partition has been modified”, or “the content of the 1 k partition and the original storage data are inconsistent”. In some embodiments, the detection result is sent to a printer for printing out, or is delivered to another display device for displaying.

Note that the storage integrity information may be the system file information, the information quantity of the system file information, and the checksums of the storage data in the other partition, or a combination thereof. Moreover, the detection method may be performed to only one of the storage integrity information or performed concurrently to several storage integrity information to determine whether the current system on the mobile terminal is complete. Preferably, in order to acquire the detailed information of the current system on the mobile terminal, in one embodiment, the detection is performed to the current system file information of the mobile terminal, the information quantity of the system file information, and the checksums of the storage data in the other partitions. That is the detection is performed to the current system file information of the mobile terminal, and to the information quantity of the system file information, and subsequently to the checksums of the storage data in the other partitions. The sequence of the detections performed to the three type information is not limited to the order described in the embodiment, and the implementation of the detection procedure may be realized by the embodiments in the previous description, and is not repeated here for brevity. The detection procedure is adopted to be performed on the current system of the mobile terminal, which not only increases the accuracy of the detection result, but also allows a test personnel to accurately determine whether the mobile terminal is under warranty, while providing system diagnosis for maintenance on the mobile terminal.

In another embodiment, a detection button is configured in a recovery mode on the mobile terminal, which may trigger the mobile terminal entering into the detection procedure. The recovery mode is an engineering mode on the mobile terminal. Under the recovery mode, the mobile terminal may be recovered to a factory setting, the system on the mobile terminal may be upgraded or backed up, and other operations may be performed. In the embodiment, the detection button is added to the recovery mode to trigger the mobile terminal entering into the detection procedure.

Referring to FIG. 4, illustrating an embodiment of present invention, where the step of receiving the test instruction includes:

Step S401: receive a predefined key instruction in a power-on procedure, and the mobile terminal enters an engineering mode according to the predefined key instruction.

In the power-on procedure of the mobile terminal, the test personnel may press a predefined key to enter the recovery mode. The predefined key may be a power button, a volume button, or a combined button of the power button and the volume button. In other embodiments, the mobile terminal is entered the recovery mode by touching a virtual button on the touch panel. In the power-on procedure of the mobile terminal, the mobile terminal enters the recovery mode upon receiving the predefined key instruction.

Step S402: receive a selection instruction which selects from a function menu for checking the system integrity in the engineering mode to receive the test instruction.

There are various function menus in an interface of the recovery mode, e.g., a function menu for recovering the factory setting. In the embodiment, a function menu which is used to detect the system integrity is added to the interface of the recovery mode. The test personnel may select the function menu to trigger entering the detection procedure and performing the detection to the mobile terminal.

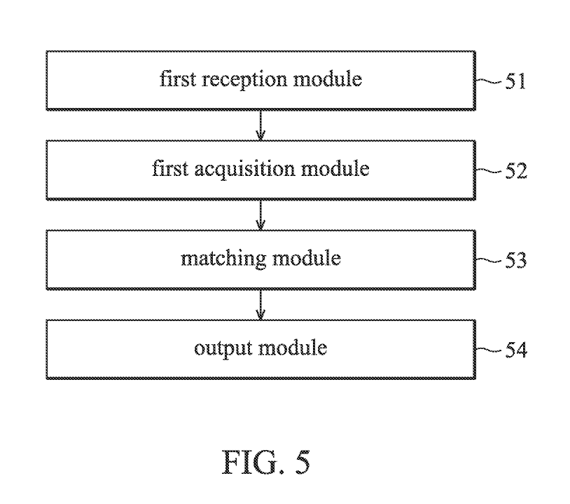

FIG. 5 is illustrated a mobile terminal according to an embodiment of present invention, wherein the mobile terminal, which adopts the above detection method, includes a first reception module 51, a first acquisition module 52, a matching module 53 and an output module 54.

The first reception module 51 receives the test instruction. The first acquisition module 52 acquires the current storage integrity information of the mobile terminal based on the test instruction. The storage integrity information is the information indicating whether the information stored in the mobile terminal is complete. When the current system on the mobile terminal is the original system, the current information stored on the mobile terminal is complete; when the current system on the mobile terminal is not the original system, the current information stored on the mobile terminal is incomplete. The original system is also referred to as the official system, and may be the official system on the mobile terminal before it is shipped out of the factory, or may be the updated official system on the mobile terminal after it is shipped out of the factory.

Specifically, the storage integrity information may be the system file information in the system partition or file information in the other partitions, and may be the system version information, system modification time, and so on.

The matching module 53 matches the current storage integrity information acquired by the first acquisition module 52 to the original storage integrity information. The original storage integrity information is the storage integrity information in the original system. The current storage integrity information is compared to the original storage integrity information. When the matching is successful, the current storage integrity information is consistent with the original storage integrity information, the current information stored on the mobile terminal is complete, and the current system on the mobile terminal is a complete system, the output module 54 outputs the information that the current system on the mobile terminal is a complete system. When the matching is unsuccessful, the current storage integrity information is inconsistent with the original storage integrity information, the current information stored on the mobile terminal is incomplete, and the current system on the mobile terminal is not the original system but a modified system. The current system on the mobile terminal is an incomplete system. The output module 54 outputs the information that the current system on the mobile terminal is an incomplete system. Therefore, it can be determined that the system on the mobile terminal is no longer the original system or the official system but a modified non-official system based on the output result, thereby providing a maintenance reference for the malfunction of the mobile terminal, and determining whether the mobile terminal is still under the warranty.

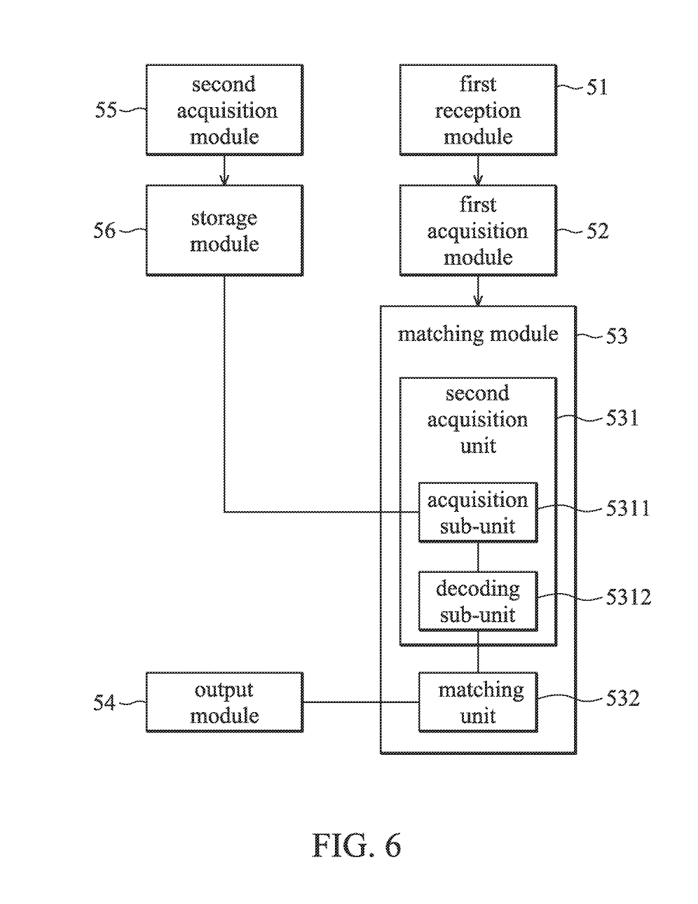

In another embodiment of the mobile terminal, the original system is the official system carried on the mobile terminal before being shipped out, the original storage integrity information is the storage integrity information before being shipped out. In this embodiment, the original storage integrity information is stored into the mobile terminal before the mobile terminal is shipped out to provide original comparison information for the detection after being shipped out. Referring to FIG. 6, the mobile terminal further includes a second acquisition module 55 and a storage module 56. The second acquisition module 55 acquires the storage integrity information in the mobile terminal before the mobile terminal is shipped out to generate the original storage integrity information of the mobile terminal. The second acquisition module 55 acquires the storage integrity information after the mobile terminal is manufactured and before being shipped out. The storage integrity information may be the system file information of the system partition and the file information of the other partitions before the mobile terminal is shipped out, and may be the system creation time and the version information, from which the original storage integrity information can be obtained. The current storage integrity information is the storage integrity information after the mobile terminal is shipped out, and may be the system file information of the system partition and the file information of the other partitions after the mobile terminal is shipped out.

The storage module 56 stores the original storage integrity information acquired by the second acquisition module 55 into the predetermined storage area in the encrypted form. Specifically, the storage module 56 writes the original storage integrity information into a file and then encrypts the file to provide an encrypted file recording the original storage integrity information. The encrypted file is equivalent to a database storing the original storage integrity information. Moreover, the storage module 56 then compresses the encrypted file to store the compressed file into the predetermined storage area.

In other words, the original storage integrity information is generated by acquiring the original information associated with the storage integrity of the mobile terminal before the mobile terminal is shipped out, and is stored in the predetermined storage area in the encrypted form. The current storage integrity information is the current information associated with the storage integrity of the mobile terminal after the mobile terminal is shipped out.

The original storage integrity information is stored in the encrypted form to prevent the original storage integrity information from being modified illegitimately and to provide accurate original comparison information to ensure the accuracy of the detection result.

After the mobile terminal is shipped out, when the first reception module 51 receives the test instruction, the first acquisition module acquires the current storage integrity information. The matching module 53 includes a second acquisition module 531 and a matching unit 532. The second acquisition module 531 acquires the original storage integrity information from the predetermined storage area of the mobile terminal. The matching unit 532 compares the current storage integrity information to the original storage integrity information.

Furthermore, the second acquisition module 531 includes an acquisition sub-unit 5311 and a decryption sub-unit 5312. The acquisition sub-unit 5311 acquires the encrypted file of the original storage integrity information from the predetermined storage area of the mobile terminal, and the decryption sub-unit 5312 decrypts the encrypted file to obtain the original storage integrity information.

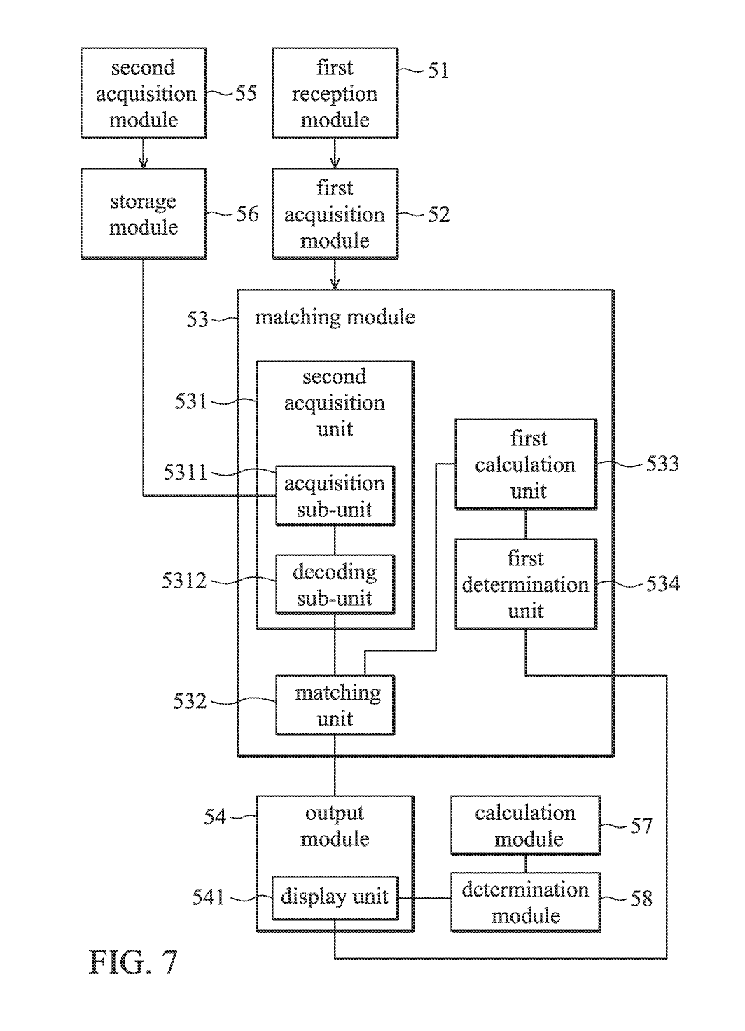

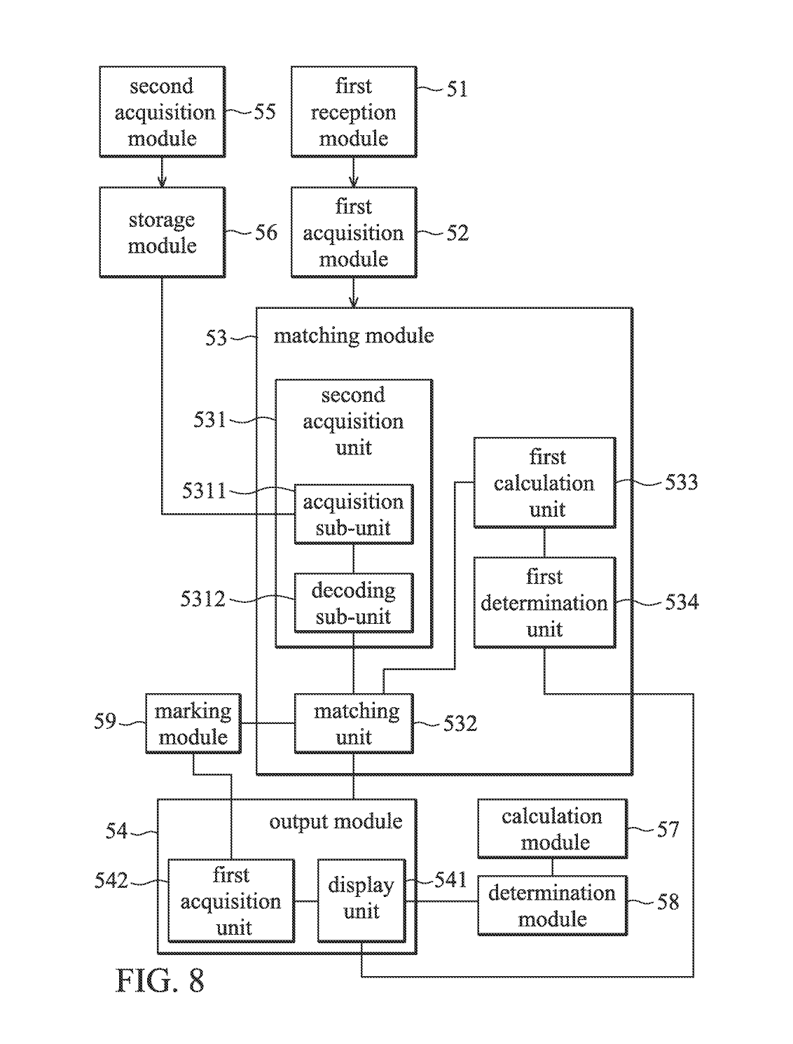

In another embodiment in FIG. 7, the storage integrity information is the system file information. The original storage integrity information is the original system file information of the system partition before the mobile terminal is shipped out. Therefore, in this embodiment, the second acquisition module 55 acquires the original system file information of the system partition before the mobile terminal is shipped out. The original system file information is the file information of the original system file, including the storage path, the file name, the file content, and the file creation time, where the original system file is the system file of the system partition before the mobile terminal is shipped out. The storage module 56 stores the original system file information in the encrypted form into the predetermined storage area.

After the first reception module 51 receives the test instruction, the first acquisition module 52 acquires the current system file information of the system partition based on the test instruction. The current system file information is the system file of the current system partition, which is the system file in the system partition of the mobile terminal upon performing the detection procedure after the mobile terminal is shipped out.

When the system is modified, the corresponding system file will also be modified, e.g., when an icon on the system desktop is modified, the icon file in the system files is also modified, the information such as an image or text stored in the icon file is replaced by a new image or text. As a consequence, the modification of the system file provides a valid reference for determining whether the system is modified.

The matching module 53 matches the current system file information to the original system file information. In particular, the second acquisition module 531 of the matching module 53 acquires the original system file information from the predetermined storage area. Further, the acquisition sub-unit 5311 of the second acquisition unit 531 acquires the encrypted file recording the original system file information from the predetermined storage area of the mobile terminal, and the decryption sub-unit 5312 decrypts the encrypted file to obtain the original system file information.

The matching module 532 matches the current system file information to the original system file information acquired by the decryption sub-unit 5312. When one of the current system file information cannot find a match from the original system file information, the original system file information does not contain any original system file information that is identical to the current system file information, and the current system file corresponding to the current system file information may be a newly added system file, or a system file modified from the original system file. Since the current system has been modified and is no longer complete, the matching unit 532 determines that the matching between the current storage integrity information and the original storage integrity information is unsuccessful. Note the current system file is the newly added system file with reference to the original system file or the official system file, the newly added system file is absent from the original system files.

When the matching fails, the current information stored on the mobile terminal is incomplete information, and the current system is incomplete and is no longer the original system, the output module 53 outputs the detection result that the current system on the mobile terminal is incomplete. The output module 53 may output the detection result by the means of displaying, i.e., the output module 54 includes a display unit 541 for displaying the information that the current system file information cannot be found from the original system file information on the screen of the mobile terminal. The test personnel may identify that the current system on the mobile terminal is no longer the original system but a modified system based on the displayed information, thereby determining if the mobile terminal is still under the warranty.

In the embodiment, the mobile terminal also includes a calculation module 57 and a determination module 58. When all current system file information finds a match from the original system file information, or the original system file information and the current system file information are the same, the calculation module 57 calculates the information quantity of the current system file information, and the determination module 58 determines whether the information quantities of the current system file information and the original system file information are consistent. When they are inconsistent, the information quantity of the current system file information is less than that of the original system file information, and some files are missing from the current system. In such condition, the matching between the current storage integrity information and the original storage integrity information is determined as unsuccessful, and the current information stored on the mobile terminal is incomplete and the current system is no longer the original system. The display unit 541 may display that the current system misses a system file to output the information of the current system being incomplete.

Preferably, in this embodiment, the system file information includes the storage path, the file name and the checksum of the system file, thus the original system file information includes the storage path, the file name and the checksum of the original system file. The second acquisition module 55 acquires the storage path, the file name and the checksum of the original system file before the mobile terminal is shipped out, in order to obtain the original system file information. The checksum of the original system file is associated with the content of the original system file. The checksum represents the content of the original system file, and is calculated through the content of the original system file using the CRC 32 or MD 5 algorithm. The storage module 56 stores the storage path, the file name and the checksum of the original system file into the predetermined storage area in the encrypted form.

The associated storage path, the file name and the file content of the system file vary with modification to the system, it is determined whether the current system is still the original system based on the storage path, the file name and the file content of the system file. The first acquisition module 52 acquires the storage path and the file name of the current system file on the mobile terminal. The matching module 53 includes a comparison unit, which is the above matching unit 532, and compares the storage path and file name of the current system file to those of the original system file.

When the storage path and file name of a current system file is not found a match from those of the original system files, or the storage paths and file names of the original system files do not contain those of the current system file, the current system file may be a newly added system file or a system file modified from the original system file, and the current system has been modified and is no longer the original system. The matching between the current storage integrity information and the original storage integrity information is determined as unsuccessful. The display unit 541 outputs the detection result by displaying that the information of the newly added system file is in the system partition.

The matching module 53 also includes a first calculation unit 533 and a first determination unit 534. When the storage path and file name of the current system file finds a match from those of the original system files, the first calculation unit 533 calculates a checksum of the current system file according to the data stored in the current system file. For example, the CRC 32 or MD5 algorithm is used to obtain the checksum of the current system. The first determination unit 534 determines whether the checksums of the current system file and the original system file are the same. When they are the same, the contents of the current system file and the original system file are identical, and the current system file has not been modified, thus the next current system file is compared. When they are different, the contents of the current system file and the original system file are different, and the current system file has been modified and is no longer the original system file. The matching between the current storage integrity information and the original storage integrity information is determined as unsuccessful. Meanwhile, the display unit 541 may display the information that the checksum calculated from the current system file and the checksum of the corresponding original system file are inconsistent, to indicate that the current system is incomplete.

FIG. 8 shows a mobile terminal according to another embodiment of the invention, which can further detect the missing file from the current system files in the system partition. The mobile terminal further includes a marking module 59, which marks the storage path and file name of the corresponding original system file when the storage path and file name of the current system file is matched from those of the original system files.

The output module 54 further includes a first acquisition unit 542 which acquires unmarked storage paths and file names of unmarked original system files. When there are unmarked storage paths and file names, the original system files having the unmarked storage paths and file names are absent from the current system, and the current system misses the original system files having the unmarked storage paths and file names. The display unit 541 may display the unmarked storage paths and file names to indicate that the current system files misses the original system files with the unmarked storage paths and file names.

Referring to FIG. 5, in another embodiment, the current storage integrity information is the information quantity of the current system file information, and the original storage integrity information is the information quantity of the original system file information. The first acquisition module 52 acquires the information quantity of the current system file information according to the test instruction to obtain the current storage integrity information on the mobile terminal. Each current system file corresponds to one current system file information, thus the information quantity of the current system file information is the file quantity of the current system files. The information quantity of the current system file information may be obtained by acquiring the file quantity of the current system files. The matching module 53 determines whether the information quantities of the current system file information and the original system file information are consistent. When they are inconsistent, a certain file is missed or added in the current system files, and the system files of the current system has been changed. The current system is no longer the original system, and the output module 54 outputs the information that the current system is an incomplete system. When they are consistent, the current system has not been modified and remains the original system, and the output module 54 outputs the information that the current system is a complete system.

It is highly probable that a file has been added to or deleted from the system files when the system is modified, in such a case, the detection method determines whether the current system file is modified by directly comparing the information quantities, thereby determining whether the current system on the mobile terminal is complete and providing an easier and simpler detection procedure.

In order to ensure the accuracy of the detection result, when the information quantities of the current system file information and the original system file information are consistent, the system file information may then be compared to the original system file information. The implementation may be realized by the preceding embodiments, description therefore is omitted here for brevity.

Referring FIG. 6, in another embodiment, the current storage integrity information is the checksum of the current storage data in the other partitions other than the system partition, the original storage integrity information is the checksum of the original storage data in the other partitions. The original storage data in the other partition are all data stored in the other partitions before the mobile terminal is shipped out, thus the original storage integrity information is the checksum of the data stored in the other partitions before the mobile terminal is shipped out. The checksum is calculated according to all data stored in the corresponding other partitions, therefore the checksum of the original storage data in the other partitions corresponds to all data stored in the other partitions before the mobile terminal is shipped out.

In this embodiment, before the mobile terminal is shipped out, the second acquisition module 55 calculates the checksum of the original storage data in the other partitions according to the storage data in the other partitions other than the system partition in the mobile terminal to acquire the original storage integrity information. The storage module 56 stores the checksum of the original storage data of the other partitions into the predetermined area in the encrypted form to provide original comparison information for the subsequent detection.

When performing the detection to the mobile terminal, the first acquisition module 52 calculates the checksum of the current storage data of the other partitions to acquire the current storage integrity information of the mobile terminal. The current storage integrity information of the mobile terminal is the checksum of the current storage data of the other partitions, each partition corresponds to a checksum of current storage data. Specifically, the checksums are calculated by applying the CRC32 algorithm or the MD5 algorithm to the current storage of the other partitions, the current storage data of the other partitions refers to the data currently stored in the other partitions, including the content of all files in the partition. The matching module 53 compares the checksums of the current storage data to the checksum of the original storage data of the other partitions.

When the checksums of the current storage data and the original storage data are the same, the current storage data is consistent with the original storage data of the other partition, and the stored content has not been modified. Thus the detection procedure proceeds to the next partition. When the checksums of the current storage data and the original storage data are different, the current storage data is different from the original storage data of the other partition, and the stored content has been modified. As a consequence, the matching between the current storage integrity information and the original storage integrity information are determined as unsuccessful, the current stored information on the mobile terminal is incomplete, and the current system on the mobile terminal is no longer the original system and is an incomplete system. At this point, the output module 54 displays the information that the content in the other partition is modified to indicate that the current system on the mobile terminal is incomplete.

In another embodiment, the engineering mode (recovery mode) of the mobile terminal may be triggered a configured detection button for triggering the mobile terminal to enter into the detection procedure. The recovery mode is an engineering mode on the mobile terminal, and the mobile terminal may be restored to a factory setting, upgraded, or backed up for the system on the mobile terminal under the recovery mode. In the present application, the detection button is configured to trigger the mobile terminal to enter the detection procedure.

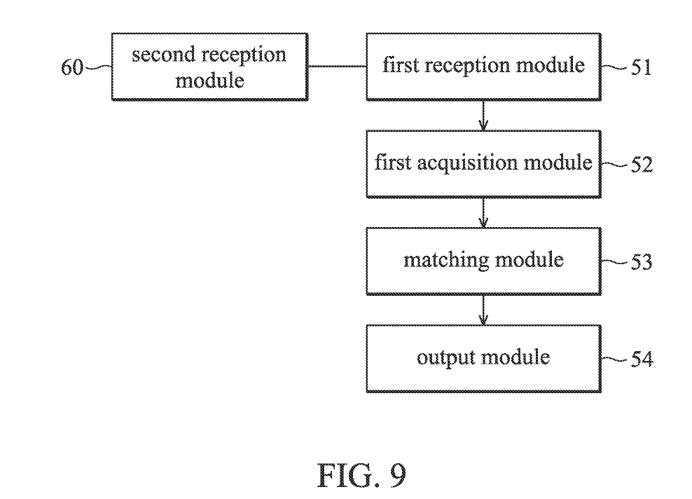

Referring to FIG. 9 for another embodiment of the invention, where a mobile terminal further includes a second reception module 60, which receives the instruction from the predefined button during the power-on procedure, to allow the mobile terminal to enter the engineering mode according to the instruction of the predefined button.

During the power-on procedure of the mobile terminal, the detection personnel may press a specific button to allow the mobile terminal to enter the recovery mode. The specific button may be a power button, a volume button, or a combined button thereof. In other embodiments, the mobile terminal may be entered the recovery mode by touching a virtual button on the touch panel. In the power-on procedure of the mobile terminal, the mobile terminal is entered the recovery mode upon receiving the predefined key instruction.

The first reception module 51 receives a selection instruction which selects from a function menu for checking the system integrity in the engineering mode. There are various function menus in an interface of the recovery mode, e.g., a function menu for recovering the factory setting. In the embodiment, a function menu which is used to detect the system integrity is added to the interface of the recovery mode. The test personnel may select the function menu to trigger entering the detection procedure and performing the detection to the mobile terminal.

The above description is made for the purpose of illustrating the general principles of the invention and should not be taken in a limiting sense. The scope of the invention is best determined by reference to the appended claims.

As used herein, the term “determining” encompasses calculating, computing, processing, deriving, investigating, looking up (e.g., looking up in a table, a database or another data structure), ascertaining and the like. Also, the term “determining” may include resolving, selecting, choosing, establishing and the like.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or another programmable logic device, discrete gate or transistor logic, discrete hardware components or any combination thereof designed to perform the functions described herein. A general purpose processor may be a microprocessor, but in the alternative, the processor may be any commercially available processor, controller, micro controller or state machine.

The operations and functions of the various logical blocks, modules, and circuits described herein may be implemented in circuit hardware or embedded software codes that can be accessed and executed by a processor.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A detection method, adopted by a mobile terminal, comprising:
receiving a test instruction;
acquiring current storage integrity information of the mobile terminal according to the test instruction;
matching the current storage integrity information to original storage integrity information; and
outputting information indicating that a current system on the mobile terminal is an incomplete system when the matching fails.

2. The detection method of claim 1, wherein the step of acquiring current storage integrity information of the mobile terminal comprises:
acquiring current system file information of system partitions of the mobile terminal and/or an information quantity of the current system file information of the system partitions of the mobile terminal to acquire the current storage integrity information of the mobile terminal; and
the step of matching the current storage integrity information to the original storage integrity information comprises:
comparing the current system file information to original system file information, and/or determining whether the information quantity of the current system file information is consistent with that of the original system file information, when one of the current system file information cannot be found in the original system file information, and/or when the information quantity of the current system file information is inconsistent with that of the original system file information, determining that the matching of the current storage integrity information and original storage integrity information fails.

3. The detection method of claim 2, wherein the step of comparing the current system file information to the original system file information comprises:
comparing a storage path and a file name of a current system file to a storage path and a file name of an original system file;
when the storage paths and the file names of the current system file can not be found in the original system file, determining that the matching of the current storage integrity information and original storage integrity information fails; and
when the storage paths and the file names of the current system file can be found in the original system file, calculating a checksum of the current system file according to the data stored in the current system file, determining whether the calculated checksum is identical to a checksum of the original system file, and when determining the calculated checksum is different from the checksum of the original system file, determining that the matching of the current storage integrity information and original storage integrity information fails.

4. The detection method of claim 3, wherein the step of outputting information indicating that a current system on the mobile terminal is an incomplete system when the matching fails comprises:
when the storage paths and the file names of the current system file can not be found in the original system file, displaying information that additional system file is added to the system partitions, to indicate that the current system on the mobile terminal is an incomplete system; and
when determining the calculated checksum is different from the checksum of the original system file, displaying information indicating that contents of the current system file and the original system file are inconsistent to indicate that the current system on the mobile terminal is an incomplete system.

5. The detection method of claim 3, wherein after the step of comparing the current system file information to the original system file information, the detection method further comprises:
when one storage path and one file name of the current system file can be found in the original system file, marking the corresponding storage path and the file name of the original system file; and
the step of outputting the information indicating that the current system on the mobile terminal is an incomplete system comprises:
acquiring an unmarked storage path and file name among all storage paths and file names of the original file system, and displaying the unmarked storage path and file name to indicate the current system lacks an original system file corresponding to the unmarked storage path and file name.

6. The detection method of claim 1, wherein the step of acquiring the current storage integrity information of the mobile terminal comprises:
calculating a checksum of current storage data of other partition to acquire the current storage integrity information of the mobile terminal, wherein the other partition is a partition other than the system partition; and
the step of matching the current storage integrity information to the original storage integrity information comprises:
comparing the checksum of the current storage data of the other partition and a checksum of original storage data;
when the checksum of the current storage data of the other partition and the checksum of the original storage data are inconsistent, determining that the matching of the current storage integrity information and original storage integrity information fails; and
the step of outputting the information indicating that the current system on the mobile terminal is an incomplete system comprises:
displaying information indicating that the content of the current storage data corresponding to the other partition has been modified.

7. The detection method of claim 1, wherein the step of matching the current storage integrity information to the original storage integrity information comprises:
acquiring the original storage integrity information from a predetermined storage area of the mobile terminal; and
matching the current storage integrity information to the acquired original storage integrity information.

8. The detection method of claim 7, wherein the step of acquiring the original storage integrity information from a predetermined storage area of the mobile terminal comprises:
acquiring an encrypted file recording the original storage integrity information from the predetermined storage area of the mobile terminal; and
decrypting the encrypted file to acquire the original storage integrity information.

9. The detection method of claim 8, wherein:
the original storage integrity information of the mobile terminal are generated by acquiring original information associated with storage integrity of the mobile terminal before the mobile terminal is shipped out from a factory, and the original storage integrity information is stored in the predetermined storage area in a form of the encrypted file; and
the current storage integrity information are information associated with current storage integrity of the mobile terminal after the mobile terminal is shipped out from the factory.

10. The detection method of claim 9, wherein:
the original information associated with storage integrity of the mobile terminal comprises original system file information of system partitions of the mobile terminal; and/or the original information associated with storage integrity of the mobile terminal comprises at least a checksum of original storage data of another partition, wherein the checksum of the original storage data of the another partition is calculated according to storage data in the another partition other than the system partition.

11. A mobile terminal, comprising:
a first reception module, receiving a test instruction;
a first acquisition module, acquiring current storage integrity information of the mobile terminal according to the test instruction;
a matching module, matching the current storage integrity information to original storage integrity information; and
an output module, outputting information indicating that a current system on the mobile terminal is an incomplete system when the matching fails.

12. The mobile terminal of claim 11, wherein:
the first acquisition module acquires current system file information of system partitions of the mobile terminal, and/or an information quantity of the current system file information of the system partitions of the mobile terminal to acquire the current storage integrity information of the mobile terminal; and
the matching module compares the current system file information to original system file information, and/or determines whether the information quantity of the current system file information is consistent with that of the original system file information, when one of the current system file information cannot be found in the original system file information, and/or when the information quantity of the current system file information is inconsistent with that of the original system file information, determines that the matching of the current storage integrity information and original storage integrity information fails.

13. The mobile terminal of claim 12, wherein the matching module comprises:
a comparison unit, comparing a storage path and a file name of a current system file to a storage path and a file name of an original system file, when the storage paths and the file names of the current system file can not be found in the original system file, determining that the matching of the current storage integrity information and original storage integrity information fails;
a first calculation unit and a first determination unit;
wherein when the storage paths and the file names of the current system file can be found in the original system file are matched, the first calculation unit calculates a checksum of the current system file according to the data stored in the current system file; and the first determination unit determines whether the calculated checksum is identical to a checksum of the original system file, and when determining the calculated checksum is different from the checksum of the original system file, determines that the matching of the current storage integrity information and original storage integrity information fails.

14. The mobile terminal of claim 13, wherein the output module comprises a display unit, when the storage paths and the file names of the current system file cannot be found in the original system file, displaying the information that additional system file is added to the system partitions to indicate that the current system on the mobile terminal is an incomplete system; and when determining the calculated checksum is different from the checksum of the original system file, displaying information that contents of the current system file and the original system file are inconsistent to output the information indicating that the current system on the mobile terminal is an incomplete system.

15. The mobile terminal of claim 13, further comprises a marking unit, when one storage path and one file name of the current system file can be found in the original system file, marking the corresponding storage path and the file name of the original system file;
wherein the output module comprises a first acquisition unit and a display unit;
the first acquisition unit acquires an unmarked storage path and file name among all storage paths and file names of the original file system, and
the display unit displaying the unmarked storage path and file name to indicate the current system lacks an original system file corresponding to the unmarked storage path and file name.

16. The mobile terminal of claim 11, wherein:
the matching module calculates a checksum of current storage data of other partition to acquire the current storage integrity information of the mobile terminal, wherein the other partition is a partition other than the system partition;
the matching module compares the checksum of the current storage data of the other partition and a checksum of original storage data, and when the checksum of the current storage data of the other partition and the checksum of the original storage data are inconsistent, determines that the matching of the current storage integrity information and original storage integrity information fails; and
the output module displays information about content of the current storage data corresponding to the other partition has been modified.

17. The mobile terminal of claim 11, wherein:
the second acquisition unit acquires the original storage integrity information from a predetermined storage area of the mobile terminal; and
the matching unit matches the current storage integrity information to the acquired original storage integrity information.

18. The mobile terminal of claim 17, wherein the second acquisition unit includes an acquisition sub-unit and a disruption sub-unit;
the acquisition sub-unit acquires an encrypted file recording the original storage integrity information from the predetermined storage area of the mobile terminal; and
the disruption sub-unit decodes the encrypted file to acquire the original storage integrity information.

19. The mobile terminal of claim 18, further comprising:
a second acquisition module, acquiring original information associated with storage integrity of the mobile terminal before the mobile terminal is shipped out from a factory to generate the original storage integrity information of the mobile terminal; and
a storage module, storing in the predetermined storage area in a form of the encrypted file; and
wherein the current storage integrity information is information associated with current storage integrity of the mobile terminal before the mobile terminal is shipped out from the factory.

20. The mobile terminal of claim 19, wherein:
the second acquisition module acquires the original system file information of the system partition of the mobile terminal to acquire the storage integrity of the mobile terminal; and/or the original information associated with storage integrity of the mobile terminal include at least a checksum of original storage data of another partition; and the checksum of the original storage data of the another partition is calculated by storage data in the another partition other than the system partition.
